(19) United States
(12) Patent Application Publication
(10) Pub. No.: US 2016/0248056 A1
(43) Pub. Date: Aug. 25, 2016

(54) BATTERY PACK

(71) Applicant: SAMSUNG SDI CO., LTD., Yongin-si (KR)

(72) Inventor: Sora LEE, Yongin-si (KR)

(21) Appl. No.: 15/002,422

(22) Filed: Jan. 21, 2016

(30) Foreign Application Priority Data
Feb. 25, 2015 (KR) 10-2015-0026747

(51) Int. Cl. H01M 2/10; H01M 2/20; H01M 2/26; H01M 2/02; H01M 2/06

(52) U.S. Cl. CPC H01M 2/1016; H01M 2/0275; H01M 2/06; H01M 2/26; H01M 2/202

(57) ABSTRACT

A battery pack, including two or more battery cells; and a cell holder to which the battery cells are coupled, the cell holder including a base portion extending across the battery cells in an arrangement direction of the battery cells; and a side portion extending downward from the base portion and covering a lateral side of the battery cells, an extended end portion of the side portion including a skirt surface protruding from the lateral side of the battery cells.

### CROSS-REFERENCE TO RELATED APPLICATION

Korean Patent Application No. 10-2015-0026747, filed on Feb. 25, 2015, in the Korean Intellectual Property Office, and entitled: “Battery Pack,” is incorporated by reference herein in its entirety.

### BACKGROUND

1. Field

One or more exemplary embodiments relate to a battery pack.

2. Description of the Related Art

Unlike primary batteries, secondary batteries may be rechargeable. Secondary batteries may be used as energy sources of devices such as mobile devices, electric vehicles, hybrid electric vehicles, electric bicycles, and uninterruptible power supplies. Single-cell secondary batteries or multi-cell secondary batteries (secondary battery packs) in which a plurality of battery cells are electrically connected may be used according to the types of external devices using the secondary batteries.

### SUMMARY

Embodiments may be realized by providing a battery pack, including two or more battery cells; and a cell holder to which the battery cells are coupled, the cell holder including a base portion extending across the battery cells in an arrangement direction of the battery cells; and a side portion extending downward from the base portion and covering a lateral side of the battery cells, an extended end portion of the side portion including a skirt surface protruding from the lateral side of the battery cells.

The side portion may cover an upper portion of the lateral side of the battery cells, and a lower portion of the lateral side of the battery cells may be exposed from the side portion.

The skirt surface may be substantially perpendicular to the lateral side of the battery cells.

The side portion may include first and second side portions extending from opposite sides of the base portion.

The first and second side portions may be on front and rear end portions of the base portion in the arrangement direction of the battery cells.

Skirt surfaces of the first and second side portions may be substantially a same height.

The battery cells may include electrode tabs, and the base portion may extend across upper sides of terraces of the battery cells from which the electrode tabs extend.

The side portion may extend downward from the base portion to a height lower than the terraces of the battery cells so as to cover the terraces.

The battery cells may be pouch type battery cells packaged with flexible exterior materials.

The battery cells may be coupled to the cell holder in such a manner that electrode tabs of the battery cells are inserted through the cell holder.

The battery pack may further include a connection tab disposed above the cell holder and connected to the electrode tabs.

The battery pack may further include a case to accommodate the cell holder to which the battery cells are coupled.

The case may include may further include first and second cases coupled to each other to face each other with the cell holder being disposed therebetween.

### BRIEF DESCRIPTION OF THE DRAWINGS

Features will become apparent to those of skill in the art by describing in detail exemplary embodiments with reference to the attached drawings in which:

FIG. 1 illustrates a view of a battery pack according to an exemplary embodiment;

FIG. 2 illustrates a perspective view of battery cells depicted in FIG. 1;

FIG. 3 illustrates an exploded perspective view of the battery pack depicted in FIG. 1;

FIGS. 4 and 5 illustrate a perspective view and a side view of a welding support; and

FIG. 6 illustrates a perspective view of a case.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete. and will fully convey exemplary implementations to those skilled in the art.

In the drawing figures, the dimensions of features may be exaggerated for clarity of illustration. Like reference numerals refer to like elements throughout.

As used herein, the term “and/or” includes any and all combinations of one or more of the associated listed. Expressions such as “at least one of,” when preceding a list of elements, modify the entire list of elements and do not modify the individual elements of the list.

A battery pack will now be described in detail with reference to the accompanying drawings, in which exemplary embodiments are shown.

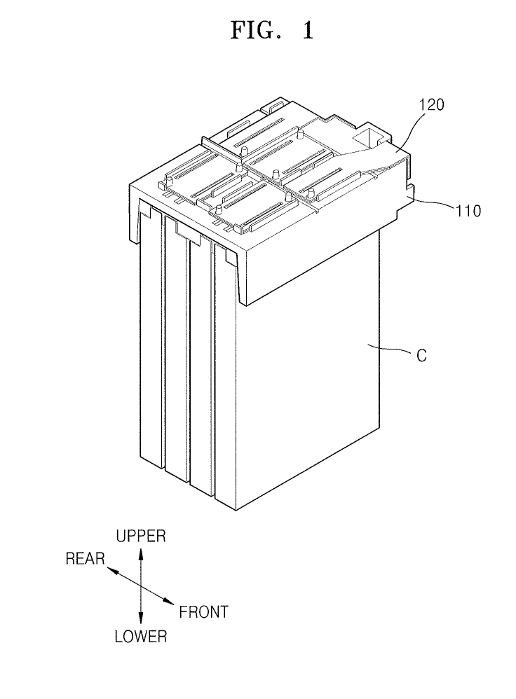

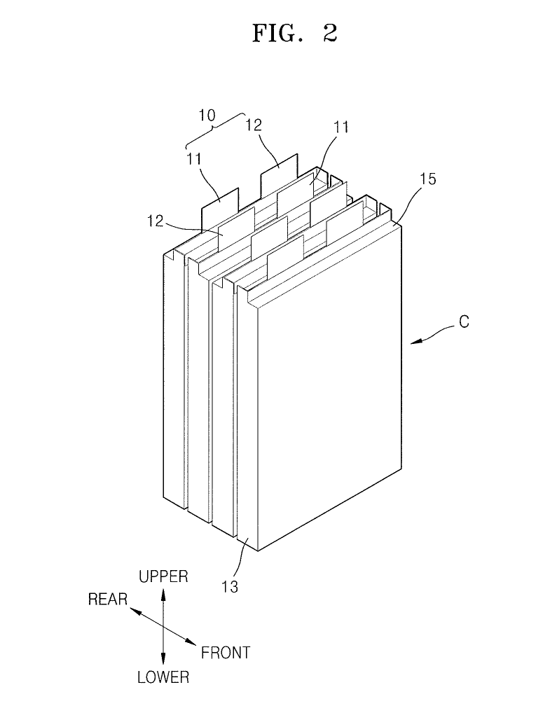

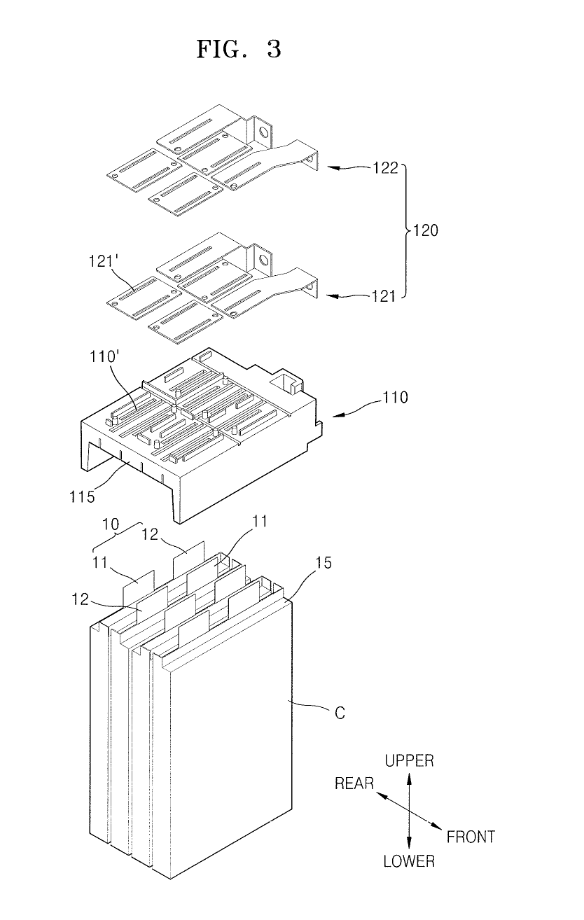

FIG. 1 illustrates a view of a battery pack according to an exemplary embodiment. FIG. 2 illustrates a perspective view of battery cells depicted in FIG. 1. FIG. 3 illustrates an exploded perspective view of the battery pack depicted in FIG. 1.

Referring to FIG. 1, the battery pack may include at least two battery cells C and a cell holder 110 to which the battery cells C may be coupled. The battery cells C may include lithium-ion battery cells. Each of the battery cells C may include an electrode assembly having a stacked structure formed by first and second electrode plates having different polarities and a separator disposed between the first and second electrode plates. A plurality of first and second electrode plates and a plurality of separators may be stacked in the electrode assembly to increase the output power and capacity of the battery cell C.

Referring to FIG. 2, the battery cells C may include exterior materials 13 to seal the electrode assemblies. The battery cells C may be pouch type battery cells including relatively flexible exterior materials 13 instead of metal cans. Each of the battery cells C may include electrode tabs 10 electrically connected to the electrode assemblies and extending outward from the exterior materials 13. Each of the battery cells C may include first and second electrode tabs 11 and 12 respectively making electrical connection with the first and second electrode plates, and having different polarities. In this specification, the term “electrode tab(s) 10” refers to one or both of the first and second electrode tabs 11 and 12. The battery cells C may include terraces 15 from which the electrode tabs 10 extend outward.

Referring to FIG. 3, the battery cells C may be coupled to the cell holder 110. The battery cells C may be coupled to the cell holder 110 in such a manner that the electrode tabs 10 of the battery cells C are exposed on an upper surface of the cell holder 110. The cell holder 110 may support and hold the battery cells C, and the battery cells C may be maintained at proper positions when inserted into the cell holder 110. The cell holder 110 may structurally combine the battery cells C as a single module.

The cell holder 110 may include a plurality of tab holes 110′ corresponding to the battery cells C. The electrode tabs 10 extending from the battery cells C may be inserted through the tab holes 110′ and exposed to the outside. The tab holes 110′ may be paired such that the first and second electrode tabs 11 and 12 extending from each of the battery cells C may be inserted through a pair of the tab holes 110′. For example, the first and second electrode tabs 11 and 12 extending from one of the battery cells C may be inserted through a pair of the tab holes 110′, and then the first and second electrode tabs 11 and 12 may be bent forward and backward in opposite directions to make electrical connection with neighboring battery cells C disposed in front and rear directions.

Battery cells C neighboring each other in a front-to-rear direction may be electrically connected to each other through connection tabs 120 superposed on the first and second electrode tabs 11 and 12 of the battery cells. Battery cells C arranged in the front-to-rear direction may be structurally modularized by the cell holder 110 and then may be electrically modularized by the connection tabs 120.

The connection tabs 120 may be superposed on the electrode tabs 10 which extend from the cell holder 110 through the tab holes 110′. Then, the connection tabs 120 may be coupled to the electrode tabs 10, for example, by welding.

The connection tabs 120 may include a pair of first and second connection tabs 121 and 122, e.g., first and second connection tab portions 121 and 122, and each pair of first and second connection tabs 121 and 122 may be disposed on lower and upper sides of the electrode tabs 10 to place the electrode tabs 10 therebetween. As described above, the electrode tabs 10 may be sandwiched between the first and second connection tabs 121 and 122 of the connection tabs 120 disposed on the lower and upper sides of the electrode tabs 10, and electric connection between the electrode tabs 10 and the connection tabs 120 may be made more smoothly. The electric contact area between the connection tabs 120 and the electrode tabs 10 may be increased, and moreover, the coupling strength between the connection tabs 120 and the electrode tabs 10 may be improved.

For example, the electrode tabs 10 extending from the battery cells C may be inserted through the tab holes 110′ of the cell holder 110 and tab holes 121′ of the first connection tabs 121 and exposed on upper surfaces of the first connection tabs 121, and the second connection tabs 122 may be superposed on the upper surfaces of the first connection tabs 121 on which the electrode tabs 10 are exposed.

The cell holder 110 may include the support ribs 115 protruding toward the battery cells C. The support ribs 115 may protrude downward toward the battery cells C. The support ribs 115 may support portions of the battery cells C, for example, the terraces 15 of the battery cells C. For example, the battery cells C may be coupled to the cell holder 110 through a lower side of the cell holder 110, the support ribs 115 may prevent the terraces 15 of the battery cells C from colliding with a lower surface of the cell holder 110 and may maintain a proper distance between the cell holder 110 and the terraces 15 of the battery cells C, and the electrode tabs 10 may be prevented from being damaged during a welding process. The support ribs 115 may protrude from the cell holder 110 toward the terraces 15 of the battery cells C, the coupling height of the battery cells C may be regulated to maintain a proper distance between the cell holder 110 and the battery cells C, and the cell holder 110 may be damaged less by collision, and the electrode tabs 10 may be damaged less during welding.

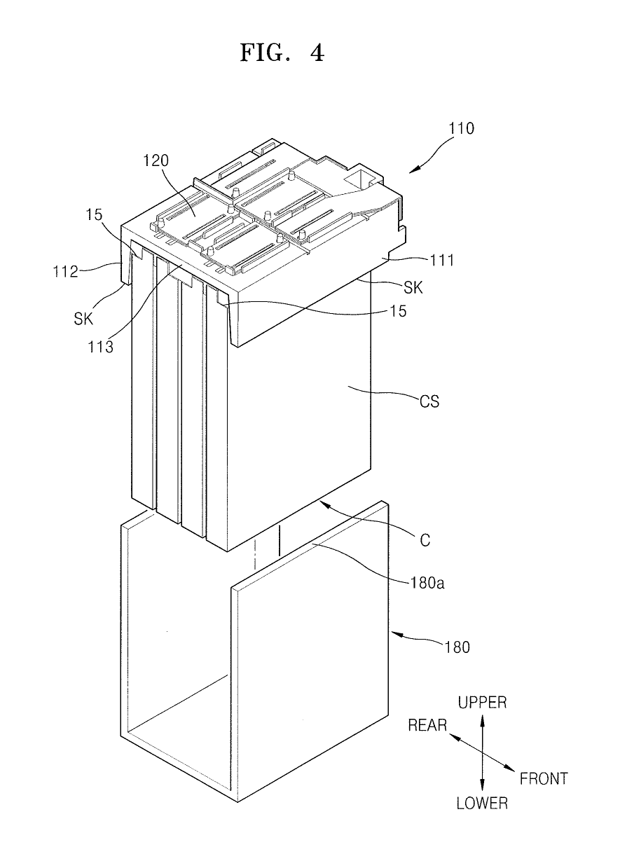

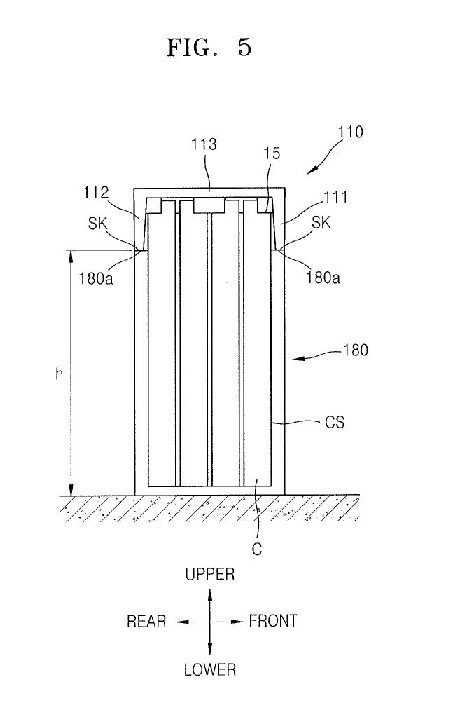

FIGS. 4 and 5 illustrate a perspective view and a side view of a welding support 180.

Referring to FIGS. 4 and 5, the cell holder 110 may include: a base portion 113 disposed on top of the battery cell and extending in an arrangement direction of the battery cells C; and first and second side portions 111 and 112 extending from the base portion 113 to cover lateral sides of the battery cells C.

The base portion 113 may occupy the largest portion of the area of the cell holder 110 and provide basic functions of the cell holder 110. For example, the base portion 113 may combine the battery cells C as a single module and may support the connection tabs 120 electrically connecting the battery cells C. For example, the base portion 113 may extend across upper sides of the battery cells C, for example, upper sides of the terraces 15 of the battery cells C.

The first and second side portions 111 and 112 may extend downward from the base portion 113. For example, the first and second side portions 111 and 112 may extend from front and rear ends of the base portion 113 in the arrangement direction of the battery cells C. The first and second side portions 111 and 112 may cover and protect lateral sides CS of the outermost battery cells C in the arrangement direction of the battery cells C. For example, the first and second side portions 111 and 112 may extend longer than the terraces 15 of the battery cells C and may protect portions of the battery cells C. The first and second side portions 111 and 112 may cover upper portions of the lateral sides CS of the battery cells C, and lower portions of the lateral sides CS of the battery cells C may be exposed from the first and second side portions 111 and 112.

The first and second side portions 111 and 112 may cover the electrode tabs 10 extending from the terraces 15 of the battery cells C for insulating the electrode tabs 10. In an exemplary embodiment, as described above, the battery cells C may be pouch type battery cells packaged with the flexible exterior materials 13, which may be relatively weak compared to metal cans, and the first and second side portions 111 and 112 may enhance the structural rigidity of the battery cells C.

The first and second side portions 111 and 112 may extend downward from both end portions of the base portion 113, and extended end portions of the first and second side portions 111 and 112 may include skirt surfaces SK protruding from the lateral sides CS of the battery cells C. As described later, the skirt surfaces SK of the first and second side portions 111 and 112 may be brought into contact with the welding support 180.

The connection tabs 120 may be welded, and the first and second side portions 111 and 112 may support the cell holder 110 at a constant height. For example, a structure for supporting the cell holder 110 at a certain height from the floor may be used when a welding electrode is pushed against the cell holder 110 in a welding process. If the battery cells C are pushed by a welding electrode in a state in which the battery cells are directly placed on the floor, the battery cells C may be compressed and damaged. The first and second side portions 111 and 112 may support the cell holder 110 at a certain height.

The connection tabs 120 and the electrode tabs 10 may be welded, and the welding support 180 may be disposed under the first and second side portions 111 and 112 of the cell holder 110. The first and second side portions 111 and 112 may be placed on the welding support 180, and welding may be performed in a state in which the cell holder 110 is supported by the welding support 180. The first and second side portions 111 and 112 may have a skirt shape protruding from the battery cells C for coupling with the welding support 180. The skirt surfaces SK of the first and second side portions 111 and 112 may be brought into contact with upper surfaces 180a of the welding support 180 when the cell holder 110 is supported by the welding support 180. The skirt surfaces SK of the first and second side portions 111 and 112 may be substantially perpendicular to the lateral sides CS of the battery cells C. For example, in a state in which the skirt surfaces SK of the first and second side portions 111 and 112 are in tight contact with the upper surfaces 180a of the welding support 180, the cell holder 110 may be securely supported for a welding process. The skirt surfaces SK of the first and second side portions 111 and 112 and the upper surfaces 180a of the welding support 180 may be parallel with each other and perpendicular to the lateral sides CS of the battery cells C, and surface contact with each other may be made.

The skirt surfaces SK of the first and second side portions 111 and 112 may be formed substantially at the same height (h). For example, the cell holder 110 may be uniformly supported in the front-to-rear direction, and welding may be stably performed. The upper surfaces 180a of the welding support 180 that make contact with the skirt surfaces SK of the first and second side portions 111 and 112 may also be located at the same height (h). The welding support 180 may have a symmetric shape in the front-to-rear direction, and the welding support 180 may be coupled to the first and second side portions 111 and 112 without having to consider the orientation of the welding support 180 relative to the first and second side portions 111 and 112.

Before a welding process, the positions of the connection tabs 120 and the electrode tabs 10 may be temporarily fixed relative to each other owing to a support structure provided by the first and second side portions 111 and 112 and the welding support 180. The welding support 180 may support the battery cells C to adjust relative heights of the electrode tabs 10 and the connection tabs 120. In a stable state in which the positions of the connection tabs 120 and the electrode tabs 10 are temporarily fixed relative to each other as described above, welding may be performed, and uniform welding strength and a high degree of welding quality may be obtained. The welding support 180 may be removed after the welding process. After the battery pack is completely manufactured, the welding support 180 may not constitute a part of the battery pack.

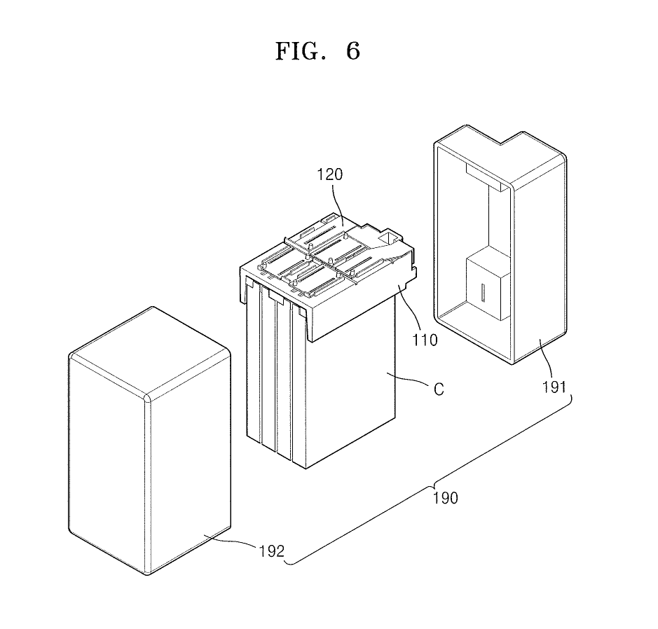

FIG. 6 illustrates a perspective view of a case 190.

Referring to FIG. 6, the cell holder 110 to which the battery cells C may be coupled may be disposed in the case 190, and the case 190 may form the exterior of the battery pack. For example, the case 190 may include first and second cases 191 and 192 that may be coupled to each other. The first and second cases 191 and 192 may be coupled to each other in mutually-facing directions in a state in which the cell holder 110 to which the battery cells C may be coupled may be disposed between the first and second cases 191 and 192. The battery cells C may be disposed in the first and second cases 191 and 192 and protected from environmental agents.

With reference to FIGS. 3, 5, and 6, processes for manufacturing the battery pack of an exemplary embodiment will be described. First, referring to FIG. 3, the battery cells C may be coupled to the cell holder 110. For example, the battery cells C may be coupled to the cell holder 110 from the lower side of the cell holder 110 so that the electrode tabs 10 of the battery cells C may be inserted into the tab holes 110′ of the cell holder 110.

Next, the connection tabs 120 may be coupled to the cell holder 110. For example, the connection tabs 120 may be disposed on pairs of neighboring electrode tabs 10.

Next, as shown in FIG. 5, the welding support 180 may be disposed under the cell holder 110. The welding support 180 may be placed in such a manner that the upper surfaces 180a of the welding support 180 may make contact with the skirt surfaces SK of the first and second side portions 111 and 112 of the cell holder 110.

After the cell holder 110 is securely supported at a certain height from the floor by the welding support 180 as described above, a welding process may be performed. The connection tabs 120 and the electrode tabs 10 may be coupled to each other through the welding process. After the connection tabs 120 are completely welded, the welding support 180 may be removed. Then, the manufacturing of the battery pack may be completed in a state in which the battery cells C are structurally and electrically combined as a module.

As shown in FIG. 6, the cell holder 110 to which the battery cells C may be coupled may be disposed in the case 190. For example, the first and second cases 191 and 192 of the case 190 may be coupled to each other to face each other in a state in which the cell holder 110 to which the battery cells C may be coupled may be disposed between the first and second cases 191 and 192.

In a comparative example, the connection tabs 120 and the electrode tabs 10 may be welded together by using a welding jig. According to the comparative example, a welding jig having a complicated structure may be used, additional processes and time may be required to assemble the welding jig and remove the welding jig, and manufacturing costs may be increased.

In an exemplary embodiment, a welding process may be performed by using the cell holder 110 constituting a part of the battery pack in a state in which the cell holder 110 may be sufficiently supported by the welding support 180 having a simple structure. The welding support 180 may be simply assembled and removed, and the welding process may be easily performed.

By way of summation and review, one or more exemplary embodiments include a battery pack that may have an improved degree of weldability by providing a stable welding support for a cell holder structurally combining a plurality of battery cells.

As described above, according to the one or more of the above exemplary embodiments, the cell holder structurally combining a plurality of battery cells may be securely supported at a certain height by the welding support, and a welding process may be stably performed above the cell holder.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
two or more battery cells; and
a cell holder to which the battery cells are coupled,
the cell holder including:
a base portion extending across the battery cells in an arrangement direction of the battery cells; and
a side portion extending downward from the base portion and covering a lateral side of the battery cells,
an extended end portion of the side portion including a skirt surface protruding from the lateral side of the battery cells.

2. The battery pack as claimed in claim 1, wherein:
the side portion covers an upper portion of the lateral side of the battery cells, and
a lower portion of the lateral side of the battery cells is exposed from the side portion.

3. The battery pack as claimed in claim 1, wherein the skirt surface is substantially perpendicular to the lateral side of the battery cells.

4. The battery pack as claimed in claim 1, wherein the side portion includes first and second side portions extending from opposite sides of the base portion.

5. The battery pack as claimed in claim 4, wherein the first and second side portions are on front and rear end portions of the base portion in the arrangement direction of the battery cells.

6. The battery pack as claimed in claim 4, wherein skirt surfaces of the first and second side portions are substantially a same height.

7. The battery pack as claimed in claim 1, wherein:
the battery cells include electrode tabs, and
the base portion extends across upper sides of terraces of the battery cells from which the electrode tabs extend.

8. The battery pack as claimed in claim 7, wherein the side portion extends downward from the base portion to a height lower than the terraces of the battery cells so as to cover the terraces.

9. The battery pack as claimed in claim 1, wherein the battery cells are pouch type battery cells packaged with flexible exterior materials.

10. The battery pack as claimed in claim 1, wherein the battery cells are coupled to the cell holder in such a manner that electrode tabs of the battery cells are inserted through the cell holder.

11. The battery pack as claimed in claim 10, further comprising a connection tab disposed above the cell holder and connected to the electrode tabs.

12. The battery pack as claimed in claim 1, further comprising a case to accommodate the cell holder to which the battery cells are coupled.

13. The battery pack as claimed in claim 12, wherein the case includes first and second cases coupled to each other to face each other with the cell holder being disposed therebetween.
